(19) United States
(12) Patent Application Publication
(10) Pub. No.: US 2015/0026231 A1
(43) Pub. Date: Jan. 22, 2015

(54) FACILITATION OF INTERACTION WITH AVAILABLE SUBJECT MATTER EXPERTS (SMES) ASSOCIATED WITH DIGITAL MULTIMEDIA SEGMENT

(71) Applicant: Springboard Technologies, LLC, Spokane Valley, WA (US)

(72) Inventor: Shane Desgroselier, Spokane Valley, WA (US)

(21) Appl. No.: 13/946,188

(22) Filed: Jul. 19, 2013

(51) Int. Cl. H04L 29/08

(52) U.S. Cl. CPC H04L 67/32
USPC 709/202

(57) ABSTRACT

Described herein are technologies related to facilitating interaction between a user and available one or more subject matter experts (SMEs) associated with selected digital multimedia segment.

### BACKGROUND

Computer networking has provided real-time communications between users in private, public, academic, business, and government environments. For example, the computer networking has enabled and accelerated new forms of human interactions between students and their teachers, between employees and their employers, and the like.

With this computer networking, the users have also expanded their ability to be resourceful in their respective field of endeavor. For example, in the academic environment, a student-user may intend to hire services of an online tutor with regard to her present school-subjects. In this example, the student-user is typically burdened with searching individual tutors in different Internet websites in order to avail the services of the online tutors.

### BRIEF DESCRIPTION OF THE DRAWINGS

FIG. 1 is an example scenario that illustrates an overview of facilitating interaction between a user and available subject matter experts (SMEs) in a network environment in accordance with the implementations described herein.

FIG. 2 is an example system in accordance with one or more implementations described herein.

FIG. 3 is an example screen-shots to demonstrate an operation of facilitating interaction with one or more available SMEs associated with selected digital multimedia segment.

FIG. 4 is example process chart illustrating an example method for facilitating interaction between a user and available SMEs in a network environment.

FIG. 5 is high-level block diagram illustrating an example computer system to implement the technology described herein.

The Detailed Description references the accompanying figures. In the figures, the left-most digit(s) of a reference number identifies the figure in which the reference number first appears. The same numbers are used throughout the drawings to reference like features and components.

### DETAILED DESCRIPTION

Disclosed herein is a technology for facilitating interaction between a user and available one or more subject matter experts (SMEs) associated with selected digital multimedia segment.

For example, the user using a mobile tablet computer is presented with a listing of digital videos of presentations. The listing of videos may be obtained from a video database on a video server. Alternatively, it may be found locally on a database of the user's tablet computer.

Each video in the database has information about one or more people associated therewith. The people associated with a particular video will be experts in the subject matter covered in that particular video. These individuals are called Subject Matter Experts (SMEs) herein. Part of their information, which is associated with the particular video, includes information about how to contact the expert in real-time. Herein, “real-time” contact includes interactive or live communication with the SME. Examples of real-time communication include audio teleconference, a video teleconference, Shot Message Service (SMS) messaging, instant message (IM) messaging, and the like.

The user will then select the video of his choice. After this user selection, availability information (i.e., status data) of the one or more SMEs associated to the selected video shown to the user. The availability information, for example, is obtained from the real-time contact information associated to the selected video.

The user will then select one or more associated SMEs of his choice. For example, the selection is based from the presented availability information of the one or more associated SMEs.

With the selected one or more chosen SMEs, the user communicates and consults with the one or more chosen SMEs.

### Exemplary Scenario

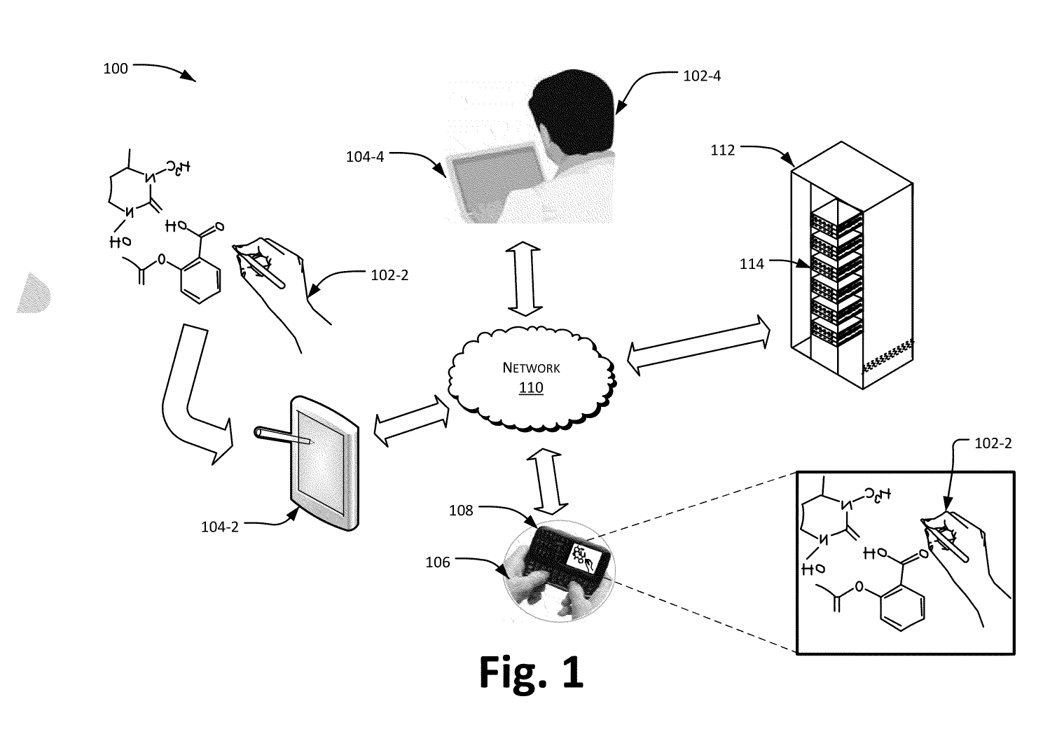

FIG. 1 illustrates an example scenario 100 that shows an overview of facilitating interaction between a user and available SMEs in a network environment. Scenario 100 shows an online SME 102-2 with an SME-device 104-2, a stand-by SME 102-4 with a SME-device 104-4, a user 106 holding a user-device 108, a network 110, and a database 112 that stores digital multimedia segments 114. The arrangement in scenario 100 illustrates, for example, a user selection of the digital multimedia segment and subsequent communication with the one or more available SMEs associated with the selected digital multimedia segment.

As an example of present implementations herein, the user-device 108 includes a display screen to present a listing of digital multimedia segments to the user 106. For example, the listing of digital multimedia segments is obtained from the digital multimedia segments 114 of the data structure 112. In another example, the listing of digital multimedia segments is derived from the user-device itself. In these examples, the digital multimedia segments are associated with the real-time contact information of one or more SMEs 102.

The real-time contact information are data that contains the names of the one or more SMEs 102 and their contact information. For example, the real-time contact information that is associated with a particular digital multimedia segment 114 includes the name of the SME 102-2, his area-of-expertise (e.g., Orthodontist), his level-of-experience (e.g., ten years), electronic mail address, instant messaging address, land line number, mobile phone number, and the like.

With the presented listing of digital multimedia segments, the user 106 has the option of choosing one or more digital multimedia segments. For example, the user 106 selects a particular digital multimedia segment 114 based from its associated SME's area-of-expertise. In this example, user-device 108 may present the listing of digital multimedia segments to the user 106 by indicating the associated SME's area-of-expertise in the display screen.

As shown, the user 106 is conversing with the SME 102-2 who is associated to the selected digital multimedia segment. Although FIG. 1 shows a limited number of SMEs (i.e., SMEs 102-2 and 102-4), in reality, the network 110 may connect multitudes of SMEs to multiple number of users. For example, multiple user-devices 108 may connect with different SMEs in different SME-devices 104.

As an example of present implementations herein, the SMEs 102 are individuals who are experts in a particular field or area of expertise. For example, SME 102-2 is an analog engineer who can be consulted in the field of electronics. In this example, the digital multimedia segment where SME 102-2 is associated can be presented as “analog engineer” in the display screen. In another example, the digital multimedia segment can also be presented by the SME's area-of-expertise and corresponding level-of-experience.

The network 110 is a generic label for remote services offered over a computer network (e.g., the Internet) that entrusts a user's data, software, and/or computation. For example, the SME-devices 104 connect to the user-devices 108 through the network 110. In this example, the network 110 facilitates wired or wireless form of communications between the SME-devices 104 and the user-devices 108.

The database structure 112 stores the digital multimedia segments 114 that are associated with the real-time contact information of the one or more associated SMEs 102. Furthermore, each digital multimedia segment 114 is associated, for example, with an address to facilitate its retrieval during the implementation of the technology as described herein.

### Exemplary System

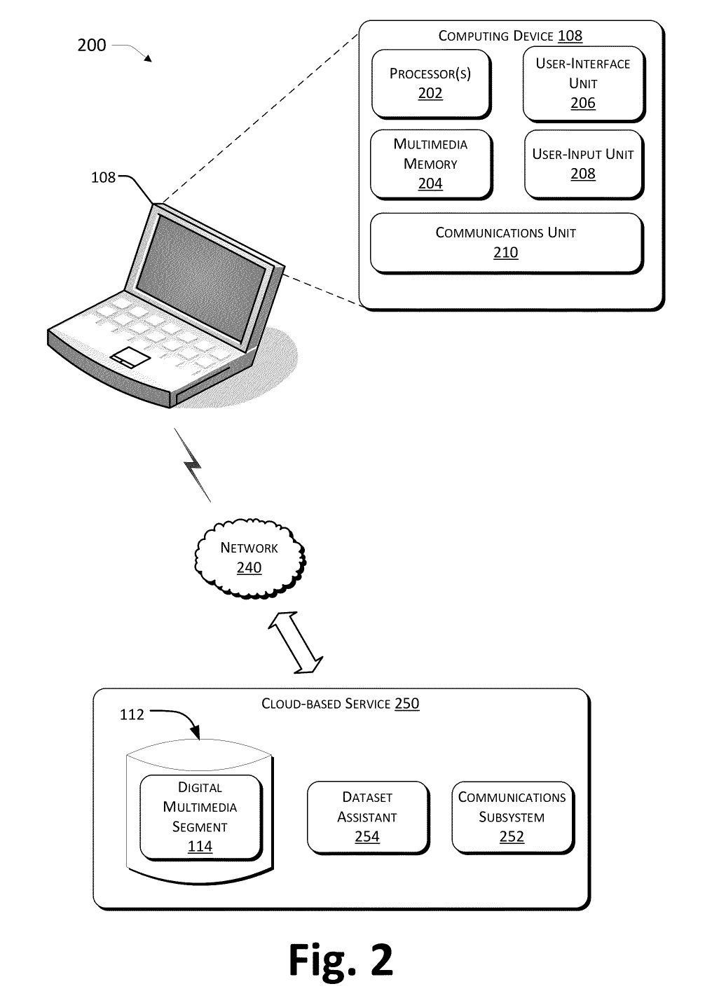

FIG. 2 illustrates an example system 200 for implementing the technology as described herein. The system 200 includes the user-device 108 (such as a laptop computer), a network 240, and cloud-based service 250.

As depicted, the user-device 108 includes one or more processor(s) 202 (or simply a processor), a multimedia memory 204, a user-interface unit 206, a user-input unit 208, and communications unit 214. These functional components may be separate or some combination of hardware units. Alternatively, the components may be implemented, at least in part, in software and thus be stored in the multimedia memory 204 and executed by the processors 202.

The multimedia memory 204, for example, is a partitioned storage for the digital multimedia segments such as the digital multimedia segments 114. As discussed above, the digital multimedia segments are associated with the real-time contact information of one or more SMEs 102. As an example illustration, a stored digital multimedia segment labeled as Table-One is shown below. In this example illustration, the real-time contact information are the data that were written inside the blocks (e.g., SME Names, area-of-expertise, etc.) while the digital multimedia segment is the Table-One itself.

TABLE ONE

| | |
|---|---|
| Subject Matter Expert (SME) | John Doe; Jane Doe; Thomas Doe |
| Names | |
| Area-of-expertise | Molecular Engineering |
| Level-of-experience | John Doe - ten years of experience; |
| | Jane Doe - five years of experience; |
| | Thomas Doe - eight years of |
| | experience |
| Electronic Mail Address | JohnDoe@gmail.com; |
| | JaneDoe@gmail.com; |
| | THomasDoe@gmail.com |
| Instant Messaging Addresses | JohnDoe@InstantMessage.com; |
| | JaneDoe@InstantMessage.com; |
| | THomasDoe@InstantMessage.com |
| Phone Number | John Doe - (222-222); Jane Doe- (333- |
| | 333); Thomas Doe - (444-444) |
| Availability-Time of Status Data | Monday Morning to Friday Evening |

The partitions of the multimedia memory 204 is furthermore assigned with specific physical addresses to facilitate retrieval of the stored digital multimedia segments. For example, the specific physical addresses can be in the form of a binary number to access the Table-One above. In this example, the Table-One can be of any size (e.g., one kilobytes) and it may depend upon the amount of the associated real-time contact information therein.

Using the user-interface unit 206, the user may select a particular digital multimedia segment from the presented listing of the digital multimedia segments. For example, the user may select the digital multimedia segment Table-One as illustrated above. In addition to Table-One, the user may select one or more digital multimedia segments. In this example, the selected digital multimedia segments are treated as input data from the user.

As an example of technology described herein, the user-input unit 208 receives the input data from the user-interface unit 206. The user-input unit 208 utilizes this input data to obtain present availability of the one or more SMEs associated with the selected digital multimedia segments. For example, the user-input unit 208 consults with the processor 202 in order to receive availability information (e.g., present availability) of the one or more associated SMEs. In this example, the one or more SMEs are associated to the selected digital multimedia segments that are stored in the multimedia memory 204.

In another example, the user-input unit 208 consults with the communications unit 210 to retrieve the availability information of the one or more associated SMEs. In this example, the one or more SMEs are associated to the selected digital multimedia segments that are stored in the cloud-based service 250.

The user-input unit 208 retrieves the present availability of the one or more associated SMEs and facilitates the presentation of this availability information to the user. For example, the user-interface unit 206 presents an indication of the one or more presently available SMEs. In this example, the user may choose the one or more presently available SMEs that he so desires. The one or more chosen SMEs are treated as SME-choice input data from the user.

The user-input unit 208 will again receive the SME-choice input data of the user through the user-interface unit 206. Afterwards, the user-input unit 208 coordinates with the communications unit 210 to communicate with the one or more chosen SMEs. For example, the communications unit 210 utilizes a communication network (e.g., network 240) to contact the one or more chosen SMEs.

The communications unit 210 establishes first a communication link between the user-device 108 and the SME-device through the network 240. For example, in a phone or video teleconference, the communications unit 210 facilitates the dialing of the phone number of the chosen SME. In this example, the communication link is the probable channel that may be used to connect the user-device 108 to the SME-device.

After establishing the communication link, the communications unit 210 will determine if the SME-device rejected or accepted the communication link. For example, if the SME-device rejected the communication link by not answering the call, then then communications unit 210 will attempt to contact another chosen SME. In this example, the communications unit 210 will again establish another communication link between the user-device and the SME-device of the other chosen SME.

As an example of current implementations herein, the network 240 may be a wired and/or wireless network. It may include the Internet infrastructure and it may be presented as the so-called “cloud.” The network 240 may include wired or wireless local area network, a cellular network, and/or the like. The network 240 links the user-device 108 with one or more network servers or cloud-based service 250.

The cloud-based service 250 includes a communications subsystem 252, a dataset assistant 254, the digital multimedia segment 114, and the database 112. The cloud-based service 250 need not be part of the so-called “cloud.” Rather, it may be described as one or more network servers or more simply as a computing system.

The communications subsystem 252 facilitates receiving of data requests from the communications unit 210. For example, the data request relates to the availability information in the selected digital multimedia segments that are stored in the digital multimedia segment 112. Similarly, the communications subsystem 252 facilitates the transmission of the retrieved availability information back to the user-device 108.

The dataset assistant 254 responds to requests from the computing devices to access the real-time contact information of a particular digital multimedia segment 114. For example, the dataset assistant 254 facilitates finding of the particular digital multimedia segment 114 that corresponds to the user-selected digital multimedia segment.

### Exemplary Screen Shots

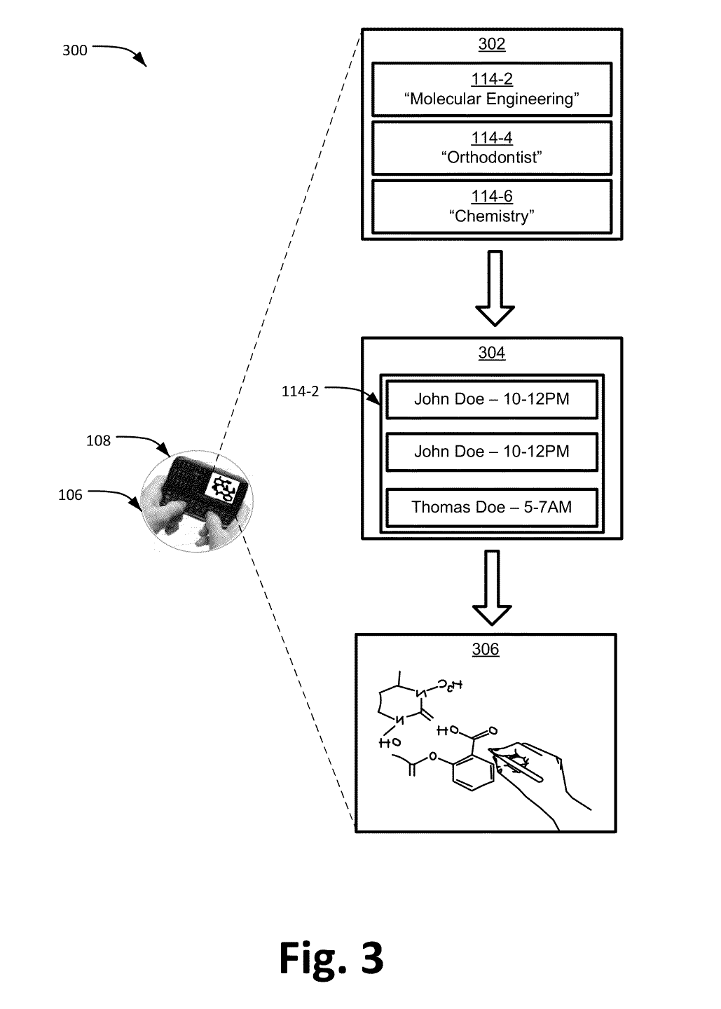

FIG. 3 illustrates an example screen-shots 300 to illustrate the technology as described herein. As shown, the screen-shots 300 includes listing 302, present-availability 304, and SME communication 306. The screen-shots 300, for example, demonstrate the operation of facilitating interaction with one or more available SMEs associated with the selected digital multimedia segments.

The listing 302 is a screen shot that presents to the user the digital multimedia segments 114-2, 114-4, etc. The listing 302 indicates to the user the choices of digital multimedia segments at the initial stage of the operation as described herein. For example, the digital multimedia segment 114-2 is represented by data contents (e.g., area-of-expertise) of the real-time contact information that is associated to it. In this example, the digital multimedia segment 114-2 is represented as “Molecular Engineering,” which is the area-of-expertise, for example, of the digital multimedia segment Table-One. Similarly, the listing 302 indicates to the user the other digital multimedia segments 114-4 and 114-6 based from the area-of-expertise of the associated SMEs (e.g., Orthodontist, Chemistry, etc.).

In another example, the digital multimedia segment 114-2 is represented by a combination of the area-of-expertise and level-of-experience of the associated SMEs (e.g., John Doe, Molecular Engineering—ten years experience).

After selecting the digital multimedia segment of his choice, the user-input unit 208 obtains availability information of the one or more SMEs associated to the selected digital multimedia segment 114. The availability information is obtained from the real-time contact information associated to the selected digital multimedia segment 114. For example, the real-time contact information of Table-one shows the availability information of John Doe to be at Monday morning to Friday evening.

The present-availability 304 is a screen shot that indicates present availability of the one or more associated SMEs. For example, if the user selected the digital multimedia segment 114-2 (e.g., Table-One), then the present-availability 304 will show the present availability of John Doe, Jane Doe, and Thomas Doe. In this example, their present availability starts from Monday morning and ends at Friday evening.

The present-availability 304 further facilitates user with the selection of the one or more associated SMEs. For example, the user chooses John Doe and disregards the two other associated SMEs (i.e., Jane Doe and Thomas Doe). In this example, the user-input unit 208 will receive the SME-choice input data, which includes John Doe as the chosen SME. The user-input unit 208 will then consult the processor 202 and the communications unit 210 in order to contact John Doe.

The SME conversation 306 is a screen shot that indicates the ongoing conversation between the user and John Doe as the chosen SME. In this conversation, John Doe is using his SME-device to communicate with the user.

### Exemplary Flowchart

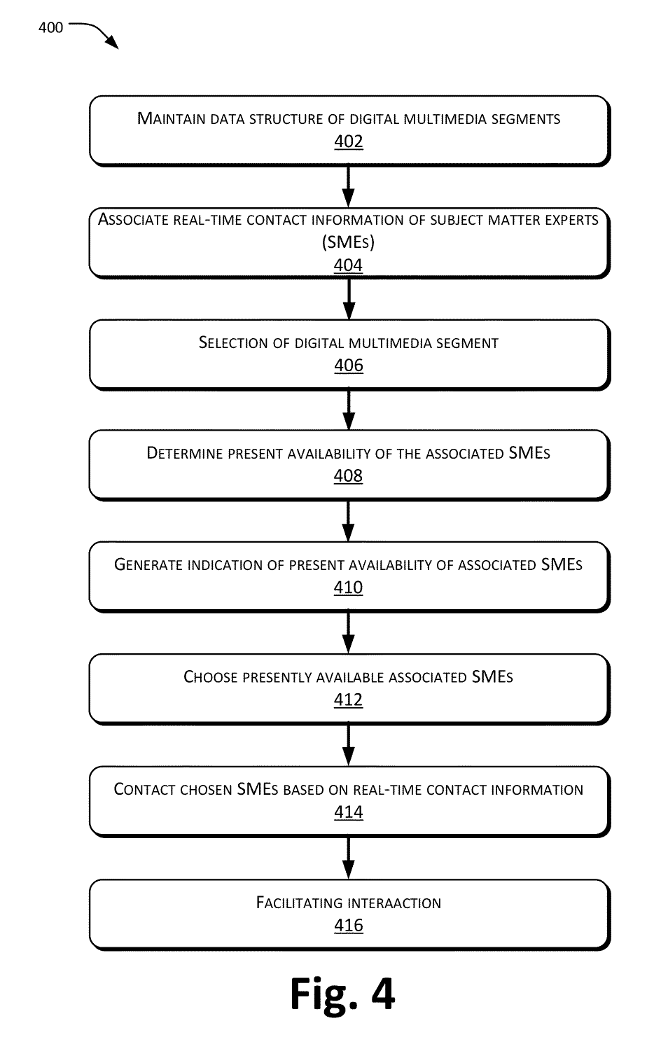

FIG. 4 illustrates an example flowchart 400 to facilitate interaction with available one or more SMEs associated with the selected digital multimedia segment.

At block 402, maintain data structure of digital multimedia segments is performed. For example, one or more digital multimedia segments 114 are stored in the data structure 112. In this example, the data structure 112 is located at cloud-based service 250. In another example, the digital multimedia segments 114 are stored at the multimedia memory 204 of the user-device 108.

In the presented listing of digital multimedia segments as shown in the listing 302 of FIG. 3, the digital multimedia segments 114 (e.g., Table-One) may be stored at the multimedia memory 204 of the user-device 108 or at the data structure 112.

At block 404, associate real-time contact information of one or more SMEs with each digital multimedia segment of the data structure. For example, for the digital multimedia segment Table-One, the real-time contact information are the area-of-expertise, level-of-experience, electronic mail address, instant messaging address, and the phone number of the one or more SMEs (i.e., John Doe, Jane Doe, and Thomas Doe). In this example, the real-time contact information is associated with the digital multimedia segment Table-One.

At block 406, selection of the digital multimedia segment is performed. For example, the user selects the digital multimedia segment Table-One from the listing of digital multimedia segments. In this example, the listing of the digital multimedia segments are shown in the display screen of the user-device.

At block 408, determine present availability of the one or more associated SMEs is performed. For example, the real-time contact information contains status data that indicate present availability of the one or more associated SMEs. Based from the status data, the user-input unit obtains the present availability (e.g., Monday morning to Friday evening) of the one or more associated SMEs is identified.

At block 410, generate an indication of the determined present availability of the one or more associated SMEs. For example, the present-availability 304 of FIG. 3 indicates the present availability of the one or more SMEs associated to the selected digital multimedia segment.

At block 412, the user chooses one or more of the associated SMEs. For example, the user indicates preference in choosing the presently available one or more associated SMEs. In this example, the user-preference is received as ranking-data by the user-input unit. In other words, the selection of the one or more chosen SMEs is based from the obtained ranking data.

For example, if the user selected Table-one, then the user may choose John Doe as a first preference and Jane Doe as a second preference.

At block 414, contact the one or more chosen SMEs based upon the associated real-time contact information is performed. For example, the communications unit establishes a communication link between the user-device and the SME-device of the one or more chosen SMEs. In this example, the communications unit determines if the SME-device accepted or rejected the communication link. In case of rejection, another SME-device is selected and the above process is repeated until the SME-device of the chosen SME accepts the communication link.

At block 416, facilitate an interaction with the one or more contacted SMEs over a communication network is performed. For example, the presentations of the selected digital multimedia segments on the user's device is synchronized with the presentation of the selected digital multimedia segments on the SME's device.

### Exemplary System

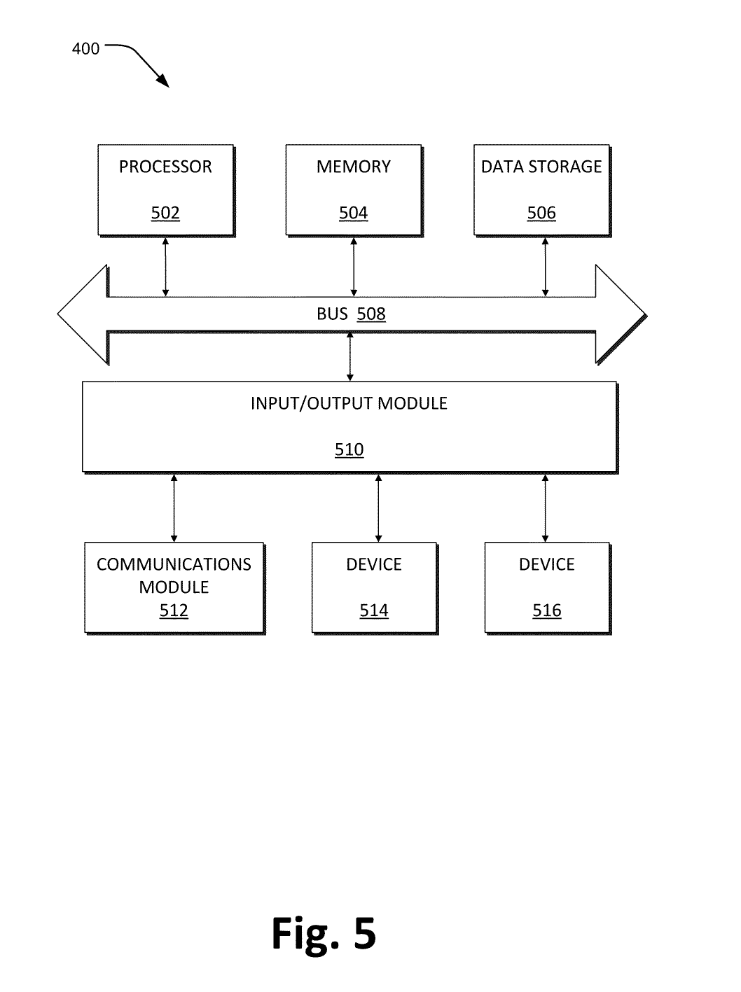

FIG. 5 is a high-level block diagram illustrating an example computer system 500 suitable for implementing the example environment 100 of FIG. 1. In certain aspects, the computer system 500 may be implemented using hardware or a combination of software and hardware.

The illustrated computer system 500 includes a processor 502, a memory 504, and data storage 506 coupled to a bus 508 or other communication mechanism for communicating information. An input/output (I/O) module 510 is also coupled to the bus 508. A communications module 512, a device 514, and a device 516 are coupled to the I/O module 510.

The processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information. The processor 502 may be used for processing information. The processor 502 can be supplemented by, or incorporated in, special purpose logic circuitry.

The memory 504 may be Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device used for storing information, a computer program, and/or instructions to be executed by the processor 502. They memory 504 may store code that creates an execution environment for one or more computer programs used to implement technology described herein.

A computer program as discussed herein does not necessarily correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

Unless indicated otherwise by the context, a module refers to a component that is hardware, firmware, and/or a combination thereof with software (e.g., a computer program.) A computer program as discussed herein does not necessarily correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

The instructions may be implemented in one or more computer program products, i.e., one or more modules of computer program instructions encoded on one or more computer readable media for execution by, or to control the operation of, the computer system 500, and according to any method well known to those of skill in the art. The term “computer-readable media” includes computer-storage media. For example, computer-storage media may include, but are not limited to, magnetic storage devices (e.g., hard disk, floppy disk, and magnetic strips), optical disks (e.g., compact disk (CD) and digital versatile disk (DVD)), smart cards, flash memory devices (e.g., thumb drive, stick, key drive, and SD cards), and volatile and non-volatile memory (e.g., random access memory (RAM), read-only memory (ROM)).

The data storage 506 may be a magnetic disk or optical disk, for example. The data storage 506 may function to store information and instructions to be used by the processor 502 and other components in the computer system 500.

The bus 508 may be any suitable mechanism that allows information to be exchanged between components coupled to the bus 508. For example, the bus 508 may be transmission media such as coaxial cables, copper wire, and fiber optics, optical signals, and the like.

The I/O module 510 can be any input/output module. Example input/output modules 510 include data ports such as Universal Serial Bus (USB) ports.

The communications module 512 may include networking interface cards, such as Ethernet cards and modems.

The device 514 may be an input device. Example devices 514 include a keyboard, a pointing device, a mouse, or a trackball, by which a user can provide input to the computer system 500.

The device 516 may be an output device. Example devices 516 include displays such as cathode ray tubes (CRT) or liquid crystal display (LCD) monitors that display information, such as web pages, for example, to the user.

### Additional and Alternative Implementation Notes

Although the SMEs and SME-devices are described as the primary example of the subjects/objects discussed herein, the technology described herein may be applied to other online interactions as well. For example, in a social networking website, the participants in the online interaction need not be professional experts but rather plain subscribers (i.e., no area-of-expertise).

In the above example of online interaction, the user may choose the digital multimedia segment that may be represented by a personal background of the other subscriber. For example, the digital multimedia segment 114-2 is indicated as gender and age (e.g., Female/twenty years old) in the listing 302 of FIG. 3.

In the above description of exemplary implementations, for purposes of explanation, specific numbers, materials configurations, and other details are set forth in order to better explain the present invention, as claimed. However, it will be apparent to one skilled in the art that the claimed invention may be practiced using different details than the exemplary ones described herein. In other instances, well-known features are omitted or simplified to clarify the description of the exemplary implementations.

The inventor intends the described exemplary implementations to be primarily examples. The inventor does not intend these exemplary implementations to limit the scope of the appended claims. Rather, the inventor has contemplated that the claimed invention might also be embodied and implemented in other ways, in conjunction with other present or future technologies.

Moreover, the word “exemplary” is used herein to mean serving as an example, instance, or illustration. Any aspect or design described herein as exemplary is not necessarily to be construed as preferred or advantageous over other aspects or designs. Rather, use of the word “exemplary” is intended to present concepts and techniques in a concrete fashion. The term “technology,” for instance, may refer to one or more devices, apparatuses, systems, methods, articles of manufacture, and/or computer-readable instructions as indicated by the context described herein.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

These processes are illustrated as a collection of blocks in a logical flow graph, which represents a sequence of operations that can be implemented in mechanics alone or a combination with hardware, software, and/or firmware. In the context of software/firmware, the execution of the instructions on the medium may cause performance of the operations described herein. For example, or more computer-readable media with processor-executable instructions stored thereon which when executed by one or more processors may cause performance of operations described herein.

Note that the order in which the processes are described is not intended to be construed as a limitation, and any number of the described process blocks can be combined in any order to implement the processes or an alternate process. Additionally, individual blocks may be deleted from the processes without departing from the spirit and scope of the subject matter described herein.

1. A method comprising:
maintaining data structure of digital multimedia segments;
associating real-time contact information of one or more subject matter experts (SMEs) with each digital multimedia segment of the data structure;
selecting a digital multimedia segment of the data structure;
based upon the real-time contact information of the SMEs associated with the selected digital multimedia segment, determining a present availability of the associated SMEs;
based upon the determining, generating an indication of the determined present availability of one or more of the associated SMEs;
choosing one or more of the associated SMEs;
contacting the one or more chosen SMEs based upon the associated real-time contact information;
facilitating an interaction with the one or more contacted SMEs over a communication network.

2. A method as recited by claim 1, wherein the real-time contact information include area-of-expertise data of the one or more associated SMEs, the area-of-expertise data indicate level-of-experience in a particular area-of-expertise of the one or more associated SMEs.

3. A method as recited by claim 1, wherein the real-time contact information is selected from a group consisting of an electronic mail address, an instant messaging address, and a phone number.

4. A method as recited by claim 1, wherein the selecting includes:
receiving input data from a user;
based on the input data, identifying the selected digital multimedia segment.

5. A method as recited by claim 1, wherein the determining includes:
obtaining status data of the one or more associated SMEs, the status data indicate whether the one or more associated SMEs are presently available;
based from the obtained status data, identifying whether the one or more associated SMEs are presently available.

6. A method as recited by claim 1, wherein the generating includes displaying the determined present availability of the one or more associated SMEs.

7. A method as recited by claim 1, wherein the choosing includes:
obtaining ranking data from a user, the ranking data indicate a preference;
based from the obtained ranking data, selecting the one or more chosen SMEs.

8. A method as recited by claim 1, wherein the contacting of the one or more chosen SMEs includes:
establishing a communication link between a user-device and a SME-device of the one or more chosen SMEs;
based on the establishing, determining whether the SME-device accepted the communication link;
in response to a communication link rejection, selecting an other SME-device of the one or more chosen SMEs;
establishing the communication link between the user-device and the other SME-device.

9. A method as recited by claim 1, wherein the facilitating of the interaction includes:
presenting the selected digital multimedia segment via a presentation device of a user;
sending the selected digital multimedia segment to one or more presentation devices of the one or more chosen SMEs over the communication network;
synchronizing the presentations of the selected digital multimedia segments on the user's presentation device and on the one or more presentation devices of the one or more SMEs.

10. One or more processor-readable media having encoded thereon processor-executable instructions that, when executed by one or more processors, direct a performance of operations, the operations comprising:
maintaining data structure of digital multimedia segments;
associating real-time contact information of one or more subject matter experts (SMEs) with each digital multimedia segment of the data structure;
receiving input data from a user, wherein the input data include a selected digital multimedia segment of the data structure;
based upon the real-time contact information of the SMEs associated with the selected digital multimedia segment, determining a present availability of the associated SMEs;
based upon the determining, generating an indication of the determined present availability of one or more of the associated SMEs;
choosing one or more of the associated SMEs;
obtaining ranking data from the user, the ranking data indicate a preference;
contacting the one or more chosen SMEs based upon the ranking data;
facilitating an interaction with the one or more contacted SMEs over a communication network.

11. One or more processor-readable media as recited by claim 10, wherein the real-time contact information include area-of-expertise data of the one or more associated SMEs, the area-of-expertise data indicate level-of-experience in a particular area-of-expertise of the one or more associated SMEs.

12. One or more processor-readable media as recited by claim 10, wherein the real-time contact information is selected from a group consisting of an electronic mail address, an instant messaging address, and a phone number.

13. One or more processor-readable media as recited by claim 10, wherein the determining includes:
obtaining status data of the one or more associated SMEs, the status data indicate whether the one or more associated SMEs are presently available;
based from the obtained status data, identifying whether the one or more associated SMEs are presently available.

14. One or more processor-readable media as recited by claim 10, wherein the contacting of the one or more chosen SMEs includes:
establishing a communication link between a user-device and a SME-device of the one or more chosen SMEs;
based on the establishing, determining whether the SME-device accepted the communication link;
in response to a communication link rejection, selecting an other SME-device of the one or more chosen SMEs;
establishing the communication link between the user-device and the other SME-device.

15. One or more processor-readable media as recited by claim 10, wherein the facilitating of the interaction includes:
presenting the selected digital multimedia segment via a presentation device of the user;
sending the selected digital multimedia segment to one or more presentation devices of the one or more chosen SMEs over the communication network;
synchronizing the presentations of the selected digital multimedia segments on the user's presentation device and on the one or more presentation devices of the one or more SMEs.

16. A user-device comprising:
a user-interface unit configured to present to a user a listing of digital multimedia segments of a data structure, the data structure includes association between real-time contact information of one or more subject matter experts (SMEs) with each digital multimedia segment;
a user-input unit configured to receive input from the user, wherein the input indicates a selected digital multimedia segment of the listing of the digital multimedia segments;
a communications unit configured to receive availability information regarding a present availability of the one or more SMEs associated with the selected digital multimedia segment,
the user-interface unit being further configured to present an indication of the present availability of the one or more associated SMEs,
the user-input unit being further configured to receive SME-choice input from the user, wherein the SME-choice input indicates the user's choice of one or more presently available SMEs;
a communication unit configured to communicate with the one or more chosen SMEs over a communication network.

17. A user-device as recited by claim 16, wherein the real-time contact information is selected from a group consisting of an electronic mail address, an instant messaging address, and a phone number.

18. A user-device as recited by claim 16, wherein the real-time contact information include area-of-expertise data of the one or more associated SMEs, the area-of-expertise data indicate level-of-experience in a particular area-of-expertise of the one or more associated SMEs.

19. A user-device as recited by claim 16, wherein the listing of digital multimedia segments is presented as a combination of area-of-expertise and level-of-experience of the one or more associated SMEs.

20. A user-device as recited by claim 16, wherein the user-input unit is further configured to receive ranking-data, the ranking-data includes user-preference.
